(19) United States
(12) Patent Application Publication
(10) Pub. No.: US 2025/0272318 A1
(43) Pub. Date: Aug. 28, 2025

(54) SYSTEMS AND METHODS OF PROVISIONING DIGITAL CONTENT IN ACCORDANCE WITH A REGULATION

(71) Applicant: Salomon Zirdok, Los Angeles, CA (US)

(72) Inventor: Salomon Zirdok, Los Angeles, CA (US)

(21) Appl. No.: 19/008,352

(22) Filed: Jan. 2, 2025

Related U.S. Application Data
(60) Provisional application No. 63/556,899, filed on Feb. 23, 2024.

(51) Int. Cl. G06F 16/3329; G06Q 10/1093; H04L 51/02

(52) U.S. Cl. CPC G06F 16/33295; G06Q 10/1093; H04L 51/02

(57) ABSTRACT

The present disclosure provides a method of provisioning digital content in accordance with a regulation. Further, the method may include receiving one or more user request data from one or more user devices associated with one or more users. Further, the method may include analyzing the one or more user request data based on at one regulation data. Further, the one or more regulation data corresponding to a regulation of one or more communities. Further, the one or more users may be associated with the one or more communities. Further, the processing device implements an AI algorithm. Further, the method may include generating one or more response data based on the analyzing. Further, the one or more response data may be compliant with the one or more regulation data. Further, the method may include transmitting the one or more response data to the one or more user devices.

The current application claims a priority to the U.S. provisional patent application Ser. No. 63/556,899 filed on Feb. 23, 2024.

### FIELD OF THE INVENTION

The present disclosure generally relates to data processing. More specifically, the present disclosure relates to systems and methods of provisioning digital content in accordance with a regulation.

### BACKGROUND OF THE INVENTION

The field of data processing is technologically important to several industries, business organizations, and/or individuals. The Internet has brought remarkable advancements and transformations to human society since its global availability. However, alongside these benefits come risks that affect everyone, particularly impacting the Jewish community and the general internet integrity and conscious community that actively seek out only meaningful, valuable or trustworthy internet content in unique ways. This is the reason why nearly 500,000 ultra-Orthodox Jewish and the general internet integrity and conscious community individuals have opted to avoid internet use and an additional 20.1 million internet users who, as Orthodox Jews, constantly find themselves in situations where they need to filter their internet usage to align with their cultural and religious values. Moreover, an additional 14 million individuals face challenges in seeking web services that adequately cater to their specific religious needs. Consequently, there exists a substantial market of potential internet users who, constrained by religious considerations, remain untapped for basic online services, those who find it challenging to use the internet within their religious guidelines, and another market tirelessly sifting through the web to find accurate results.

Therefore, there is a need for methods and systems for provisioning digital content in accordance with a regulation that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of provisioning digital content in accordance with a regulation. Further, the method may include receiving, using a communication device, one or more user request data from one or more user devices associated with one or more users. Further, the method may include analyzing, using a processing device, the one or more user request data based on at one regulation data. Further, the one or more regulation data corresponding to a regulation of one or more communities. Further, the one or more users may be associated with the one or more communities. Further, the processing device implements an AI algorithm. Further, the method may include generating, using the processing device, one or more response data based on the analyzing. Further, the one or more response data may be compliant with the one or more regulation data. Further, the method may include transmitting, using the communication device, the one or more response data to the one or more user devices.

The present disclosure provides a system for provisioning digital content in accordance with a regulation. Further, the system may include a communication device. Further, the communication device may be configured for receiving one or more user request data from one or more user devices associated with one or more users. Further, the communication device may be configured for transmitting one or more response data to the one or more user devices. Further, the system may include a processing device. Further, the processing device may be configured for analyzing the one or more user request data based on at one regulation data. Further, the one or more regulation data corresponding to a regulation of one or more communities. Further, the one or more users may be associated with the one or more communities. Further, the processing device implements an AI algorithm. Further, the processing device may be configured for generating the one or more response data based on the analyzing. Further, the one or more response data may be compliant with the one or more regulation data.

The present disclosure provides a system for provisioning digital content according to one or more regulations. Further, the system may include a client input device which may be configured for receiving one or more input data from one or more users. Further, the system may include a client processing device. Further, the client processing device may be configured for analyzing the one or more input data using an operating system module. Further, the analyzing may be based on one or more regulation data corresponding to a regulation associated with a community. Further, the client processing device may be configured for generating one or more API call data using the operating system module based on the analyzing. Further, the client processing device may be configured for generating one or more digital content data based on one or more API response data. Further, the system may include a client communication device. Further, the client communication device may be configured for transmitting the one or more API call data to one or more external systems. Further, the client communication device may be configured for receiving the one or more API response data from the one or more external systems. Further, the system may include a client output device which may be configured for presenting the one or more digital content data. Further, the one or more digital content data includes one or more of a text data, an audio data, and a video data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of provisioning digital content in accordance with a regulation, in accordance with some embodiments.

FIG. 4 illustrates a flowchart of a method 400 of provisioning digital content in accordance with a regulation including receiving, using the communication device 702, at least one preference data from the at least one user device, in accordance with some embodiments.

FIG. 5 illustrates a flowchart of a method 500 of provisioning digital content in accordance with a regulation including processing, using the processing device 704, at least one transaction, in accordance with some embodiments.

FIG. 6 illustrates a flowchart of a method 600 of provisioning digital content in accordance with a regulation including receiving, using the communication device 702, the at least one commodity description data from the at least one online service platform, in accordance with some embodiments.

FIG. 7 illustrates a block diagram of a system 700 of provisioning digital content in accordance with a regulation, in accordance with some embodiments.

FIG. 8 illustrates a block diagram of the system 700 of provisioning digital content in accordance with a regulation, in accordance with some embodiments.

FIG. 9 illustrates a block diagram of the system 700 of provisioning digital content in accordance with a regulation, in accordance with some embodiments.

FIG. 10 illustrates a block diagram of a client input device 902 included in the system 700 of provisioning digital content in accordance with a regulation, in accordance with some embodiments.

FIG. 11 illustrates a block diagram of a client output device 908 included in the system 700 of provisioning digital content in accordance with a regulation, in accordance with some embodiments.

FIG. 12 illustrates a block diagram of the system 700 of provisioning digital content in accordance with a regulation, in accordance with some embodiments.

FIG. 13 illustrates a flowchart of a method 1300 of provisioning digital content in accordance with a regulation including generating, using the processing device 704, at least one commodity name data, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

As internet devices become increasingly ubiquitous, concerns regarding internet safety, content control, and productivity have grown. Current mobile devices provide unrestricted access to a wide range of websites, services, and applications, which may lead to security vulnerabilities, exposure to inappropriate content, and decreased productivity due to distractions. There is a need for a device that provides only the necessary online functionality to have a functional modern life, safeguarding users from risks while promoting efficiency. This need is particularly relevant for parents, educators, businesses, and other users requiring a controlled digital environment.

In some embodiments, the present disclosure relates to an internet-connected mobile device that incorporates a specialized operating system (OS) designed to limit access exclusively to pre-approved APIs, AI systems, online services and web sources, ensuring a safe and distraction-free online environment. The device prevents unauthorized or harmful content from being accessed, providing enhanced security for users in sensitive, family, educational, and professional contexts.

YankiAI is a software that can be installed in specific mobile devices and tablets designed to address these concerns by offering a secure operating system that restricts internet access to only pre-approved APIs and web sources. Unlike traditional smartphones and internet devices, YankiAI ensures that users can only access a curated set of information, content and services, eliminating exposure to harmful content and minimizing distractions.

Key features include:
A secure OS that limits connectivity to trusted APIs and websites.
An administrative control panel that allows users or administrators to customize which APIs or websites content are accessible.
Compatibility with educational, corporate, and family environments requiring high levels of security and productivity.
A user-friendly interface designed to deliver essential services while preventing unauthorized access to unwanted content.

The software can be configured by device for various user profiles, including children, professionals, or seniors, providing tailored access to internet services that meet the specific needs of each group.

The core of YankiAI is its unique operating system (OS), which differs from existing mobile platforms by restricting access to a curated list of APIs and websites. The device can be pre-configured with a list of allowable sources or managed dynamically through an administrative control panel. This design provides flexibility in maintaining security while allowing essential online functionality.

### 1. Operating System (OS) Architecture:

The OS integrates advanced firewall and filtering technologies that has internet network but not no public internet or AI results access except for those directed to pre-approved APIs and web sources. This ensures that users cannot navigate beyond the specified boundaries, protecting them from malicious or inappropriate content.

### 2. API and Source Restrictions:

Only APIs connected to the software and allowed by the system administrator can be accessed by the device. This could include APIs for productivity tools, lifestyle, educational platforms, or secure corporate systems. All other cannot be downloadable and not accessible.

### 3. User Interface:

YankiAI offers a simple user interface optimized for ease of use, particularly for those unfamiliar with advanced technology. The interface is streamlined to provide access to only the essential services, such as communication tools, educational apps, or business software, depending on the user's profile.

### 4. Customizable Profiles:

The system allows for multiple user profiles to be configured, each with its own set of permissions. For example, a child's profile might limit access to educational apps and parental-approved content, or religious communities will have access to their social services and content needs while a business profile could allow access to corporate APIs and secure communication platforms.

### 5. Security Features:

The software includes several layers of security, such as encryption, secure boot, and two-factor authentication, to prevent unauthorized access and ensure that only verified APIs and sources can be connected. These features also protect against data breaches and cyber-attacks.

In some embodiments, the present disclosure provides methods, systems, apparatuses, and devices for facilitating providing an online service based on community regulations. Further, the disclosed system may be configured for developing a tailored internet system specifically for a Jewish and a general internet integrity and conscious community that opens the door to a safe and reliable online experience, while getting the opportunity to serve a market with an annual value of $50 billion dollars.

YankiAI, an exemplary embodiment of the disclosed system herein, is a digital communication solution for the general internet integrity and conscious community and the Jewish and the Orthodox market and community needs.

Based on AI technology, the disclosed system may provide an intelligent chatbot to provide the Orthodox Jewish and the general internet integrity and conscious community with secure and efficient access to unique online data services that adhere to religious guidelines for any Jewish and the general internet integrity and conscious community lifestyle and community needs to be conceived with the objective of decreasing dependency on smartphones, conventional platforms, and mobile applications.

Developed by Jewish orthodox people and a leading software development company, the disclosed system has received certification from some of the most prominent Rabbis and figures to provide a uniquely secure and efficient search engine, and online marketplace, along with an AI personal assistant, designed to streamline daily religious tasks for the community.

This is achieved through three key concepts:
1. Data—Collaborations: The disclosed system may partner with major Jewish and the general internet integrity and conscious community platforms to consolidate valuable information into one accessible hub as well as with agents from local communities to feed the system with information about events, news, and useful resources.
2. Communication and Reliable Shopping—Enterprises: YankiAI provides a dedicated interface exclusively for approved enterprises establishing a robust communication link between users and key Jewish community and the general internet integrity and conscious community enterprises, such as schools, grocery stores, restaurants, and professional services. Following this, YankiAI offers a sophisticated online retail experience, seamlessly integrating user interactions and transactions.
3. Intuitive—AI Implementation: The disclosed system may learn from Halacha and customs, serving as a seamless guide for users to navigate Jewish and the general internet integrity and conscious community religious life effortlessly.

Current features that are available on YankiAI include:
Halachic Times powered by MyZmanim;
Lectures powered by TorahAnytime;
E-commerce marketplace
Minyanim locations powered by Godaven;
Ask a Rabbi to send questions directly to Rabbi Asher Weiss and Rabbi David Yosef offices;
Contact community enterprises (i.e., organizations, stores, schools, etc.);
Hebrew Calendar;
Religious texts;
The Jewish and content conscious community newspapers
Reminders connected to Halachic Zmanim;
Kosher products list;
Yanki exclusive content from professionals and Rabbis; and
Able to understand and answer in English, Hebrew, and Spanish.

For instance, YankiAI may be configured to detect a possible learning problem in one of our user's children “David appears to need guidance in Gemara studies. I recommend contacting Rabbi Levi for tutoring, here's his contact information”.

In another instance, the disclosed system may suggest, “Should we repeat last week's order from Kosher 4me for this Shabbat?”

The present disclosure describes a Yanki mobile device designed to operate exclusively with YankiOS as its only operating system. Further, the Yanki mobile device may be a specialized device focused on simplicity and religious efficiency.

Further, the YankiAI interface may serve as the operating system for all interactions, replacing internet browsers and traditional apps and functions. This setup prioritizes a religious way of life as the baseline operation is streamlined and designed specifically for Torah study and kodesh activities. Internet filters or other protective tools are unnecessary, as it's designed in a way that inherently eliminates religious risks associated with internet use. The Yanki mobile phone is not a phone with a preventive solution, the risks just do not exist.

Further, the YankiAI may be applied to the Internet of Things (IoT) to provide highly effective solutions due to its integrated and secure nature. Further, the disclosed system may seamlessly connect and manage IoT devices like smart home and many other gadgets that are being built by the largest tech companies in the world while maintaining strict adherence to religious guidelines. Further, the disclosed system may ensure all connected devices operate within a safe and according to Halacha environment. This approach not only simplifies the management of IoT and AI devices but also aligns their functionality with our religious values.

Users Subscription: While basic services are free of charge this is limited to 5 messages a day per user, the option of using more messages and some exclusive services will be available only for paid subscribers.

Enterprises Subscription: This option involves charging businesses a fee to use a unique channel for advertising their products or services and communicating with our specific niche market users.

Sales Processing Fee: YankiAI is charging a fee for each transaction that occurs on the platform through our e-commerce system. This fee will be charged by a percentage of the sale price or a fixed amount per transaction.

The YankiAI e-commerce network is not only enhancing user experience and opening doors for medium and large businesses such as restaurants and grocery stores but also empowering entrepreneurs and smaller organizations to monetize their content and services. Additionally, the disclosed system offers a valuable tool for nonprofit organizations and synagogues seeking to promote fundraising campaigns and event ticket sales.

Personal Assistants: Leveraging the data gathered within the system, YankiAI may become a highly personalized experience for users, enabling them to effortlessly manage everything, from household bill payments to organizing events, like a kosher meal with a singer in the middle of a desert.

Further, the disclosed system may provide a YankiAI Chatbot tailored for the Orthodox Jewish community and the general internet integrity and conscious community, especially its ability to adhere to religious guidelines and integrate unique cultural norms and language processing (i.e., English, Hebrew, Spanish).

Further, the present disclosure describes a method of aggregating and consolidating information from major Jewish and the general internet integrity and conscious community platforms and local communities into a single accessible hub.

Further, the disclosed system may provide an enterprise communication interface for approved enterprises, enabling a robust communication link between users and key Jewish community and the general internet integrity and conscious community enterprises, along with its integration for online retail experiences.

Further, the disclosed system may be based on an AI Algorithm for Religious and Cultural Adaptation to learn from Halacha and customs, providing tailored guidance for users to navigate Jewish and the general internet integrity and conscious community life.

Further, the disclosed system may be configured for the integration of various services like Halachic Times, Shiure Torah, Minyanim locations, and others into a single platform, especially if this integration involves unique methodologies or technologies.

Further, the present disclosure describes unique business models or systems developed for monetizing the YankiAI service, such as the specific methods of user subscriptions, enterprise subscriptions, sales processing fees, and personalized assistant services. Further, the disclosed system may use specific machine learning techniques to predict and recommend services based on religious needs, such as identifying learning needs or suggesting repeat orders.

Further, the disclosed system may provide any proprietary content, educational material, or services offered exclusively through YankiAI, which are not available on other platforms.

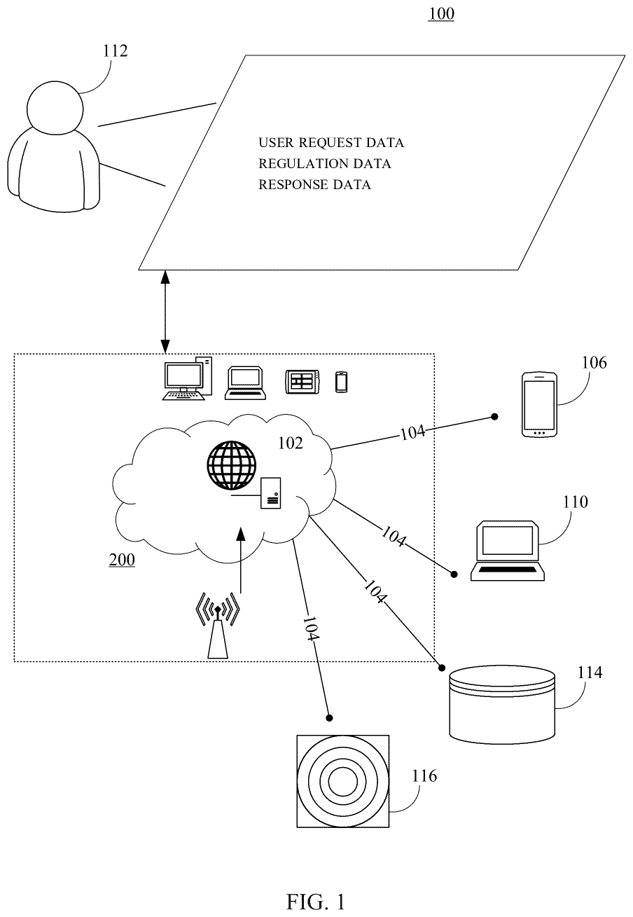

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

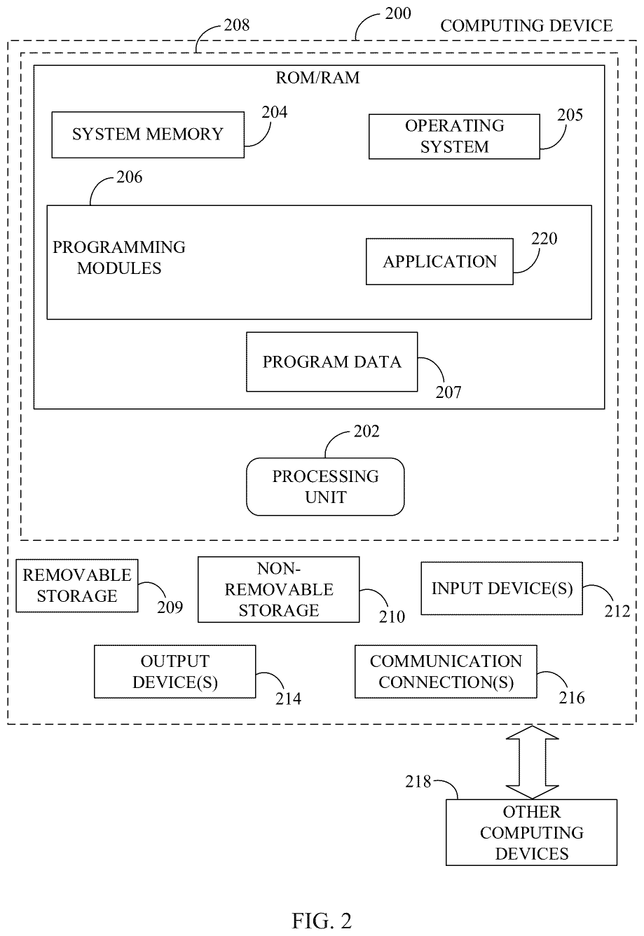

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g.

random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200′s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

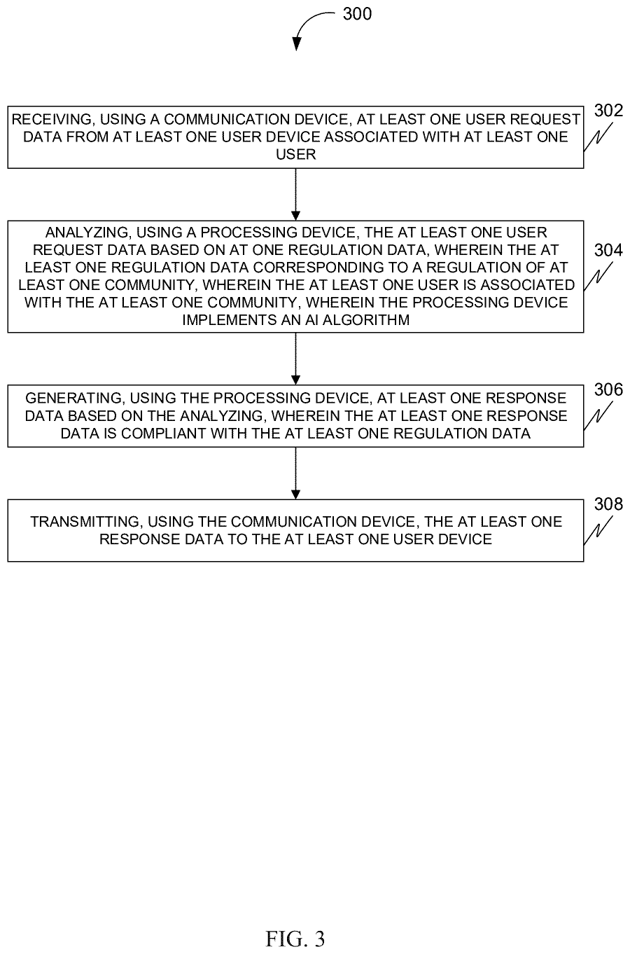

FIG. 3 illustrates a flowchart of a method 300 of provisioning digital content in accordance with a regulation, in accordance with some embodiments.

Accordingly, the method 300 may include a step 302 of receiving, using a communication device 702, one or more user request data from one or more user devices associated with one or more users. Further, the method 300 may include a step 304 of analyzing, using a processing device 704, the one or more user request data based on at one regulation data. Further, the one or more regulation data corresponding to a regulation of one or more communities. Further, the one or more users may be associated with the one or more communities. Further, the processing device 704 implements an AI algorithm. Further, the method 300 may include a step 306 of generating, using the processing device 704, one or more response data based on the analyzing. Further, the one or more response data may be compliant with the one or more regulation data. Further, the method 300 may include a step 308 of transmitting, using the communication device 702, the one or more response data to the one or more user devices.

In some embodiments, the one or more user requests includes a user query data. Further, the one or more response data includes a bot response data. Further, the AI algorithm corresponds to an intelligent chatbot. Further, the AI algorithm may be configured to conduct a conversation with the one or more users. Further, the conversation may be compliant with the one or more regulation data.

In some embodiments, the analyzing includes detecting an event data based on one or more of the one or more user request data and the one or more regulation data. Further, the event data may be associated with an event. Further, the one or more regulation data includes a calendar data. Further, the generating the one or more response data may be further based on the event data. Further, the one or more response data further includes a recommendation data corresponding to a recommendation associated with the event.

In some embodiments, the one or more user request data includes data representing performances of an activity. Further, the analyzing includes detecting a rating data representing a performance rating of the activity. Further, the one or more response data includes a recommendation data corresponding to a recommendation based on the rating data.

In some embodiments, the one or more user devices includes an Internet of Things device. Further, the one or more response data includes a command data. Further, the command data corresponds to a command to control an operational state of the one or more IoT devices.

In some embodiments, the method 300 may further include receiving, using the communication device 702, the one or more regulation data from one or more of a regulation platform and the one or more user devices. Further, the one or more regulation data corresponds to one or more of a study material, a prayer time, a calendar, a minyan location and news of the one or more communities. Further, the one or more users includes an administrator. Further, the administrator may be associated with to one or more of a religious community and an organization.

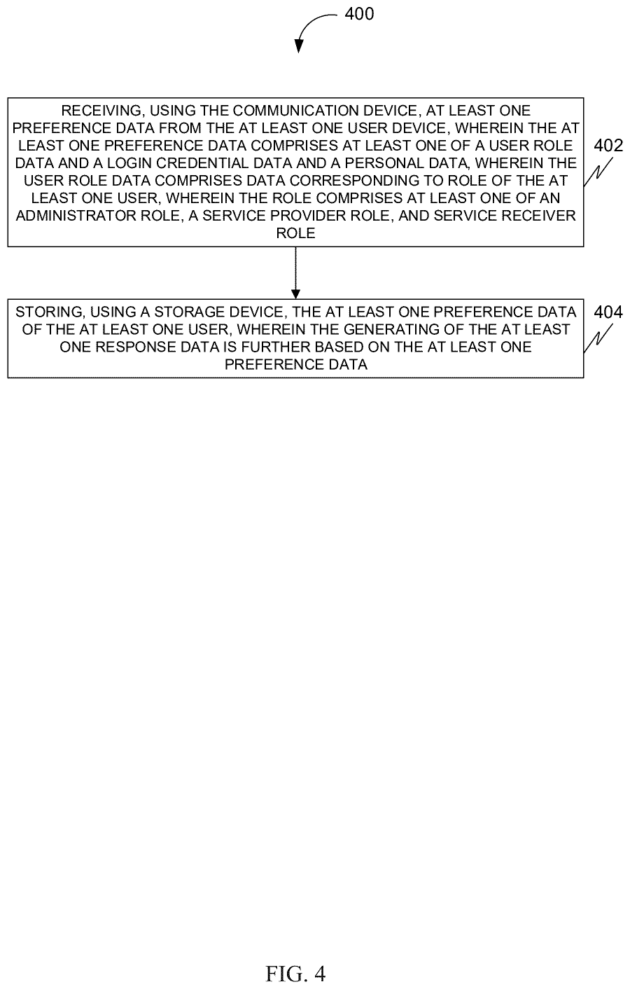

FIG. 4 illustrates a flowchart of a method 400 of provisioning digital content in accordance with a regulation including receiving, using the communication device 702, at least one preference data from the at least one user device, in accordance with some embodiments.

Further, in some embodiments, the method 400 further may include a step 402 of receiving, using the communication device 702, one or more preference data from the one or more user devices. Further, the one or more preference data includes one or more of a user role data and a login credential data and a personal data. Further, the user role data includes data corresponding to role of the one or more users. Further, the role includes one or more of an administrator role, a service provider role, and service receiver role. Further, in some embodiments, the method 400 further may include a step 404 of storing, using a storage device 802, the one or more preference data of the one or more users. Further, the generating of the one or more response data may be further based on the one or more preference data.

In some embodiments, the user request data corresponds to one or more commodities. Further, the method 300 further includes retrieving, using a storage device 802, one or more commodity description data based on the user request data. Further, the one or more response data includes the one or more commodity description data corresponding to one or more of a cost and an availability of the one or more commodities.

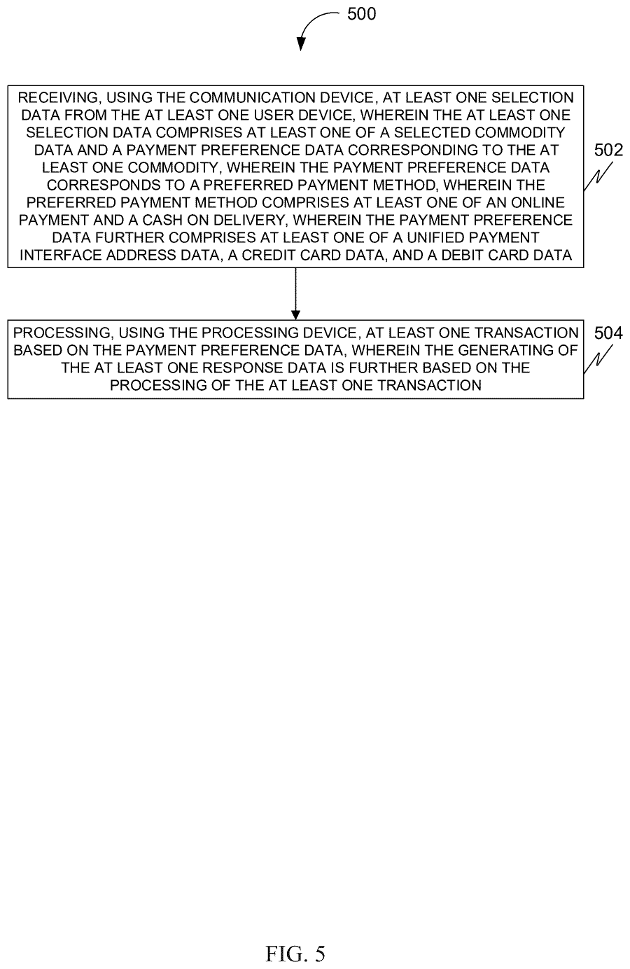

FIG. 5 illustrates a flowchart of a method 500 of provisioning digital content in accordance with a regulation including processing, using the processing device 704, at least one transaction, in accordance with some embodiments.

Further, in some embodiments, the method 500 further may include a step 502 of receiving, using the communication device 702, one or more selection data from the one or more user devices. Further, the one or more selection data includes one or more of a selected commodity data and a payment preference data corresponding to the one or more commodities. Further, the payment preference data corresponds to a preferred payment method 500. Further, the preferred payment method 500 includes one or more of an online payment and a cash on delivery. Further, the payment preference data further includes one or more of a Unified Payment Interface address data, a credit card data, and a debit card data. Further, the method 500 further may include a step 504 of processing, using the processing device 704, one or more transactions based on the payment preference data. Further, the generating of the one or more response data may be further based on the processing of the one or more transactions.

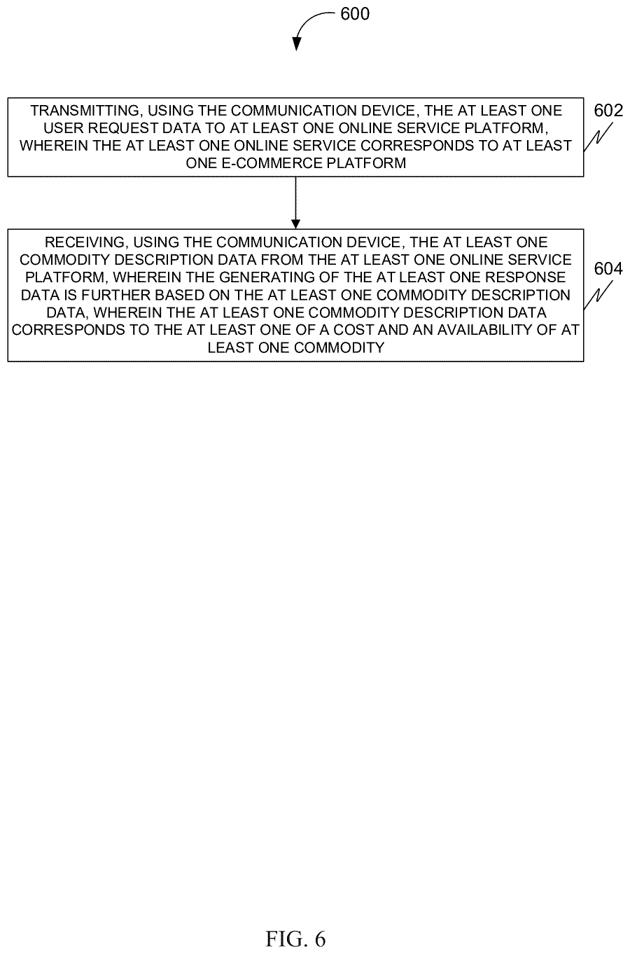

FIG. 6 illustrates a flowchart of a method 600 of provisioning digital content in accordance with a regulation including receiving, using the communication device 702, the at least one commodity description data from the at least one online service platform, in accordance with some embodiments.

Further, in some embodiments, the method 600 further may include a step 602 of transmitting, using the communication device 702, the one or more user request data to one or more online service platforms. Further, the one or more online services corresponds to one or more e-commerce platforms. Further, the method 600 further may include a step 604 of receiving, using the communication device 702, the one or more commodity description data from the one or more online service platforms. Further, the generating of the one or more response data may be further based on the one or more commodity description data. Further, the one or more commodity description data corresponds to the one or more of a cost and an availability of one or more commodities.

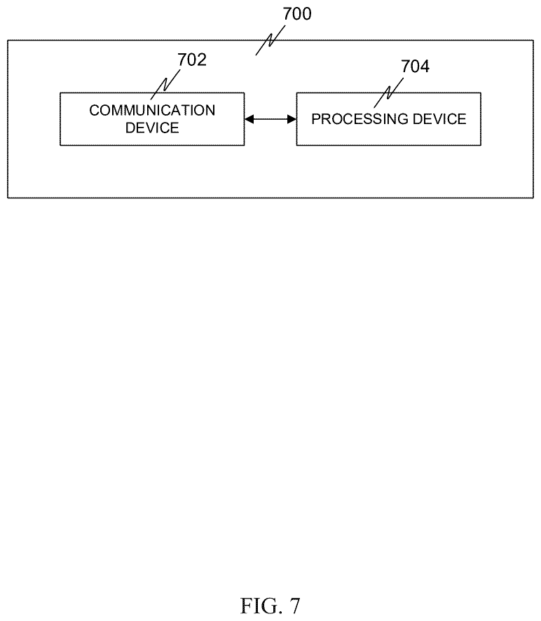

FIG. 7 illustrates a block diagram of a system 700 of provisioning digital content in accordance with a regulation, in accordance with some embodiments.

Accordingly, the system 700 may include a communication device 702. Further, the communication device 702 may be configured for receiving one or more user request data from one or more user devices associated with one or more users. Further, the communication device 702 may be configured for transmitting one or more response data to the one or more user devices. Further, the system 700 may include a processing device 704. Further, the processing device 704 may be configured for analyzing the one or more user request data based on at one regulation data. Further, the one or more regulation data corresponding to a regulation of one or more communities. Further, the one or more users may be associated with the one or more communities. Further, the processing device 704 implements an AI algorithm. Further, the processing device 704 may be configured for generating the one or more response data based on the analyzing. Further, the one or more response data may be compliant with the one or more regulation data.

In some embodiments, the one or more user requests includes a user query data. Further, the one or more response data includes a bot response data. Further, the AI algorithm corresponds to an intelligent chatbot. Further, the AI algorithm which may be configured to conduct a conversation with the one or more users. Further, the conversation may be compliant with the one or more regulation data.

In some embodiments, the analyzing includes detecting an event data based on one or more of the one or more user request data and the one or more regulation data. Further, the event data may be associated with an event. Further, the one or more regulation data includes a calendar data. Further, the generating the one or more response data may be further based on the event data. Further, the one or more response data further includes a recommendation data corresponding to a recommendation associated with the event.

In some embodiments, the one or more user request data includes data representing performances of an activity. Further, the analyzing includes detecting a rating data representing a performance rating of the activity. Further, the one or more response data includes a recommendation data corresponding to a recommendation based on the rating data.

In some embodiments, the one or more user devices includes an Internet of Things device. Further, the one or more response data includes a command data. Further, the command data corresponds to a command to control an operational state of the one or more IoT devices.

In some embodiments, the communication device 702 may be further configured for receiving the one or more regulation data from one or more of a regulation platform and the one or more user devices. Further, the one or more regulation data corresponds to one or more of a study material, a prayer time, a calendar, a minyan location and news of the one or more communities. Further, the one or more users includes an administrator. Further, the administrator may be associated with to one or more of a religious community and an organization.

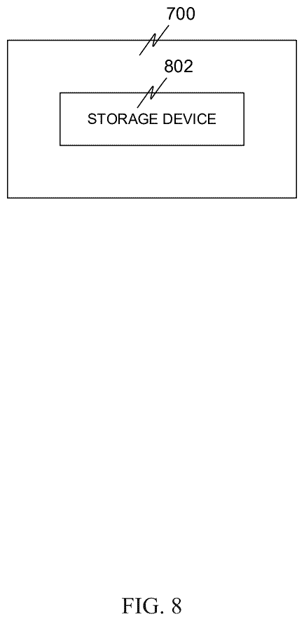

FIG. 8 illustrates a block diagram of the system 700 of provisioning digital content in accordance with a regulation, in accordance with some embodiments.

In some embodiments, the communication device 702 may be further configured for receiving one or more preference data from the one or more user devices. Further, the one or more preference data includes one or more of a user role data and a login credential data and a personal data. Further, the user role data includes data corresponding to role of the one or more users. Further, the role includes one or more of an administrator role, a service provider role, and service receiver role. Further, the system 700 further includes a storage device 802 which may be configured for storing the one or more preference data of the one or more users. Further, the generating of the one or more response data may be further based on the one or more preference data.

In some embodiments, the user request data corresponds to one or more commodities. Further, a storage device 802 which may be configured for retrieving one or more commodity description data based on the user request data. Further, the one or more response data includes the one or more commodity description data corresponding to one or more of a cost and an availability of the one or more commodities.

In some embodiments, the communication device 702 may be further configured for receiving one or more selection data from the one or more user devices. Further, the one or more selection data includes one or more of a selected commodity data and a payment preference data corresponding to the one or more commodities. Further, the payment preference data corresponds to a preferred payment method. Further, the preferred payment method includes one or more of an online payment and a cash on delivery. Further, the payment preference data further includes one or more of a Unified Payment Interface address data, a credit card data, and a debit card data. Further, the processing device 704 may be further configured for processing one or more transactions based on the payment preference data. Further, the generating of the one or more response data may be further based on the processing of the one or more transactions.

Further, in some embodiments, the communication device 702 may be further configured for transmitting the one or more user request data to one or more online service platforms. Further, the one or more online services corresponds to one or more e-commerce platforms. Further, the communication device 702 may be further configured for receiving the one or more commodity description data from the one or more online service platforms. Further, the generating of the one or more response data may be further based on the one or more commodity description data. Further, the one or more commodity description data corresponds to the one or more of a cost and an availability of one or more commodities.

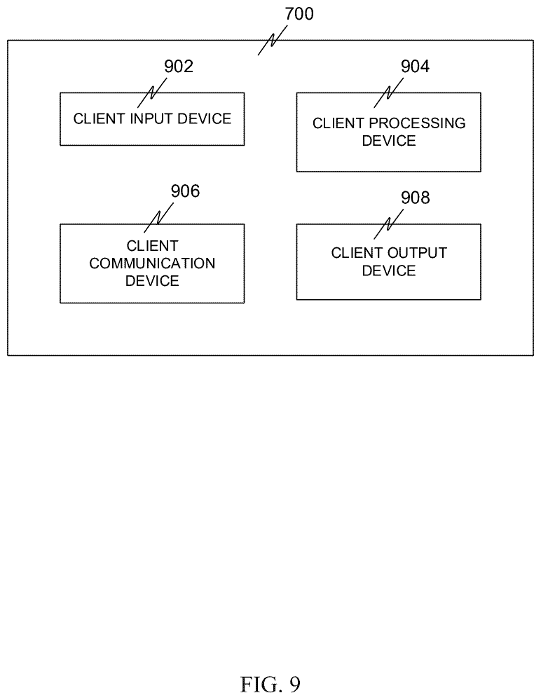

FIG. 9 illustrates a block diagram of the system 700 of provisioning digital content in accordance with a regulation, in accordance with some embodiments.

Accordingly, the system 700 may include a client input device 902 which may be configured for receiving one or more input data from one or more users. Further, the system 700 may include a client processing device 904. Further, the client processing device 904 may be configured for analyzing the one or more input data using an operating system module. Further, the analyzing may be based on one or more regulation data corresponding to a regulation associated with a community. Further, the client processing device 904 may be configured for generating one or more API call data using the operating system module based on the analyzing. Further, the client processing device 904 may be configured for generating one or more digital content data based on one or more API response data. Further, the system 700 may include a client communication device 906. Further, the client communication device 906 may be configured for transmitting the one or more API call data to one or more external systems. Further, the client communication device 906 may be configured for receiving the one or more API response data from the one or more external systems. Further, the system 700 may include a client output device 908 which may be configured for presenting the one or more digital content data. Further, the one or more digital content data includes one or more of a text data, an audio data, and a video data.

In some embodiments, the system 700 may be configured to perform exclusively based on the operating system module.

In some embodiments, the operating system module may be configured to facilitate the one or more users to access and interact with one or more websites. Further, the operating system module may be configured to replace a conventional internet browser and an app.

In some embodiments, the one or more communities corresponding to one or more of a group of parents and a group of educators.

In some embodiments, the one or more communities corresponds to one or more of a business organization, an educational organization and a religious community.

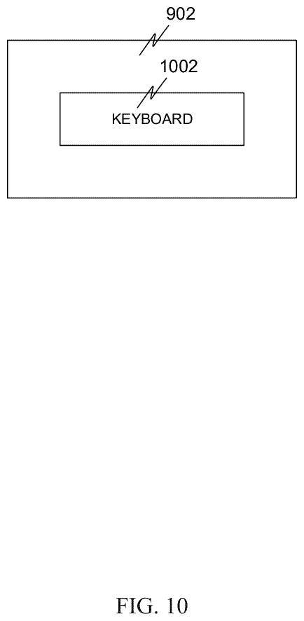

FIG. 10 illustrates a block diagram of a client input device 902 included in the system 700 of provisioning digital content in accordance with a regulation, in accordance with some embodiments.

In some embodiments, the client input device 902 includes one or more of a keyboard 1002, a mouse, a touchscreen, a camera, a touch pad and a sound capturing device.

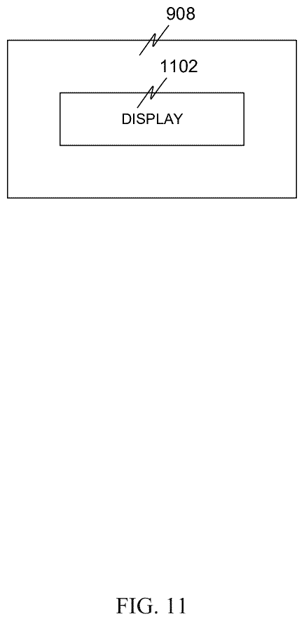

FIG. 11 illustrates a block diagram of a client output device 908 included in the system 700 of provisioning digital content in accordance with a regulation, in accordance with some embodiments.

In some embodiments, the client output device 908 includes one or more of a display 1102, a touchscreen and a speaker.

In some embodiments, the client communication device 906 may be further configured for communicating with one or more second user devices using a communication network. Further, the communication network includes one or more of an intranet and internet.

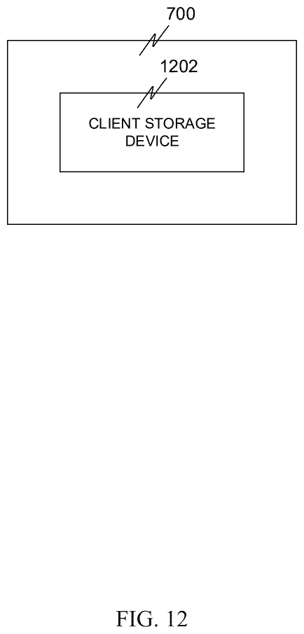

FIG. 12 illustrates a block diagram of the system 700 of provisioning digital content in accordance with a regulation, in accordance with some embodiments.

In some embodiments, the system 700 may further include a client storage device 1202 which may be configured for storing one or more of the one or more input data, the one or more regulation data and the one or more digital contents.

In some embodiments, the one or more input data includes one or more preference data of the one or more users. Further, the client storage device 1202 may be further configured for storing the one or more preference data. Further, the one or more preference data includes one or more personal data of the one or more users. Further, the generating of the one or more digital contents may be further based on the one or more preference data.

In some embodiments, the client processing device 904 may be further configured for generating the one or more API call data based on the one or more preference data.

In some embodiments, the one or more preference data includes one or more religious data representing one or more religious preferences.

In some embodiments, the one or more input data includes one or more user role data. Further, the client processing device 904 may be further configured for generating one or more of the one or more API call data and the one or more digital content data based on the one or more user role data. Further, the one or more user role includes data corresponding to a role of the one or more users. Further, the role includes one or more of an administrator role, a service provider role, and service receiver role.

In some embodiments, the one or more input data includes one or more login credential data. Further, the client processing device 904 may be further configured for generating one or more of the one or more API call data and the one or more digital content data based on the one or more login credential data. Further, the one or more login credential data associated with one or more user role data. Further, the one or more user role includes data corresponding to role of the one or more users. Further, the role includes one or more of an administrator role, a service provider role, and service receiver role.

In some embodiments, the client processing device 904 may be further configured for generating one or more administrative control panel data based on one or more user role data. Further, the at least one one or more administrative control panel data includes the one or more regulation data. Further, the one or more regulation includes data corresponding to one or more APIS and website compliant with the one or more regulation data. Further, the one or more user role data corresponds to an administrator role.

In some embodiments, the client output device 908 may be further configured for presenting the one or more administrative control panel data. Further, client input device may be further configured to receive a regulation modification data from the one or more users. Further, the processing device 704 may be configured for performing one or more of the analyzing and the generating based further on the regulation modification data.

In some embodiments, the one or more API call data corresponds to an API of one or more online service platforms.

In some embodiments, the one or more online service platforms includes one or more of an educational platform, an e-commerce platform, a corporate business platform, an AI platform, and a productivity tool.

In some embodiments, the operating system module may be further configured to allow accessing one or more online data through one or more of an API and a website based on the one or more regulation data.

In some embodiments, the operating system module implements one or more of a firewall and a web filter.

In some embodiments, the operating system module may be further configured for protecting the system 700 from one or more malicious acts corresponding to one or more of unauthorized access, a data breach and a cyber-attack.

In some embodiments, the operating system module may be configured for performing one or more of encryption process, secure boot process and two factor authentication process.

In some embodiments, the operating system module may be further configured to provide a user-interface. Further, the user-interface may be compliant with the one or more regulations.

In some embodiments, the one or more communities corresponds to one or more of a business organization, an educational organization and a religious community.

In some embodiments, the one or more communities corresponds to one or more of a group of parents and a group of educators.

In some embodiments, the method 300 may further include storing, using a storage device 802, one or more of the one or more response data, the one or more user request data and the one or more regulation data.

In some embodiments, the one or more regulation data corresponds to one or more of a law, a custom and a guideline of the one or more communities.

In some embodiments, the digital content includes a recommendation data corresponding to a recommendation of one or more of a food and a beverage.

In some embodiments, the one or more user devices includes one or more of a smartphone, a tablet, a laptop and a mobile.

In some embodiments, the one or more user request data includes an IoT data corresponding to the IoT device.

In some embodiments, the one or more response includes data corresponding to one or more of a community event and news.

In some embodiments, the one or more response data corresponds to one or more of a daily religious task and a religious guidance.

In some embodiments, the AI algorithm corresponds to a personal assistant which may be configured to help the one or more users to navigate religious life by providing continuous guidance.

In some embodiments, the personal data corresponds to one or more of a name, an age, a location, a gender, location and a marital status.

In some embodiments, the personal data includes one or more religious data.

In some embodiments, the one or more user request data relates to one or more online services.

In some embodiments, the one or more online services corresponds to one or more e-commerce platforms.

In some embodiments, the one or more online services may be provided by one or more community enterprise compliant with the regulation.

In some embodiments, the online service includes one or more of a school service, a grocery service and a restaurant service.

In some embodiments, the user request data corresponds to one or more commodities. Further, the method 300 further includes retrieving, using a storage device 802, one or more commodity description data based on the user request data. Further, the generating of the one or more response data may be further based on the one or more commodity description data. Further, the one or more commodity description includes data corresponding to one or more of cost and availability of one or more commodities.

In some embodiments, the user request data corresponds to one or more commodities. Further, the method 300 further includes retrieving, using a storage device 802, one or more commodity description data based on the analyzing. Further, the one or more response data includes the one or more commodity description data corresponding to one or more of cost and availability of one or more commodities.

In some embodiments, the method 300 may further include transmitting, using the communication device 702, one or more payment data to one or more online payment platforms. Further, the one or more online payment platforms corresponding to one or more of a digital payment platform and bank platform; and receiving, using the communication device 702, one or more transaction confirmation data from the one or more online payment platforms. Further, the one or more transaction confirmation data includes one or more of payment confirmation and rejection data.

In some embodiments, the one or more response data includes one or more of order confirmation data and payment confirmation data.

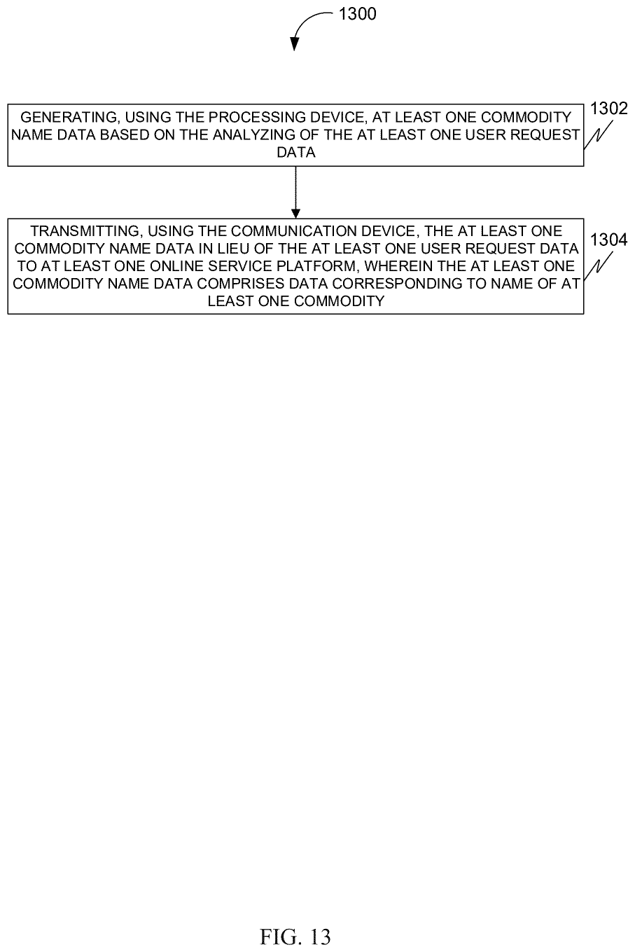

FIG. 13 illustrates a flowchart of a method 1300 of provisioning digital content in accordance with a regulation including generating, using the processing device 704, at least one commodity name data, in accordance with some embodiments.

Further, in some embodiments, the method 1300 further may include a step 1302 of generating, using the processing device 704, one or more commodity name data based on the analyzing of the one or more user request data. Further, in some embodiments, the method 1300 further may include a step 1304 of transmitting, using the communication device 702, the one or more commodity name data in lieu of the one or more user request data to one or more online service platforms. Further, the one or more commodity name includes data corresponding to name of one or more commodities.

Although the invention has been explained in relation to its preferred embodiment, it is to be understood that many other possible modifications and variations can be made without departing from the spirit and scope of the invention as hereinafter claimed.

What is claimed is:

1. A method of provisioning digital content in accordance with a regulation, the method comprising:
receiving, using a communication device, at least one user request data from at least one user device associated with at least one user;
analyzing, using a processing device, the at least one user request data based on at one regulation data, wherein the at least one regulation data corresponding to a regulation of at least one community, wherein the at least one user is associated with the at least one community, wherein the processing device implements an AI algorithm;
generating, using the processing device, at least one response data based on the analyzing, wherein the at least one response data is compliant with the at least one regulation data; and
transmitting, using the communication device, the at least one response data to the at least one user device.

2. The method of claim 1, wherein the at least one user request comprises a user query data, wherein the at least one response data comprises a bot response data, wherein the AI algorithm corresponds to an intelligent chatbot, wherein the AI algorithm is configured to conduct a conversation with the at least one user, wherein the conversation is compliant with the at least one regulation data.

3. The method of claim 1, wherein the analyzing comprises detecting an event data based on at least one of the at least one user request data and the at least one regulation data, wherein the event data is associated with an event, wherein the at least one regulation data comprises a calendar data, wherein the generating the at least one response data is further based on the event data, wherein the at least one response data further comprises a recommendation data corresponding to a recommendation associated with the event.

4. The method of claim 1, wherein the at least one user request data comprises performance data representing performance of an activity, wherein the analyzing comprises detecting a rating data representing a performance rating of the activity, wherein the at least one response data comprises a recommendation data corresponding to a recommendation based on the rating data.

5. The method of claim 1, wherein the at least one user device comprises an Internet of Things device, wherein the at least one response data comprises a command data, wherein the command data corresponds to a command to control an operational state of the at least one IoT device.

6. The method of claim 1 further comprising receiving, using the communication device, the at least one regulation data from at least one of a regulation platform and the at least one user device, wherein the at least one regulation data corresponds to at least one of a study material, a prayer time, a calendar, a minyan location and news of the at least one community, wherein the at least one user comprises an administrator, wherein the administrator is associated with to at least one of a religious community and an organization.

7. The method of claim 1 further comprising:
receiving, using the communication device, at least one preference data from the at least one user device, wherein the at least one preference data comprises at least one of a user role data and a login credential data and a personal data, wherein the user role data comprises data corresponding to role of the at least one user, wherein the role comprises at least one of an administrator role, a service provider role, and service receiver role; and
storing, using a storage device, the at least one preference data of the at least one user, wherein the generating of the at least one response data is further based on the at least one preference data.

8. The method of claim 1, wherein the user request data corresponds to at least one commodity, wherein the method further comprises retrieving, using a storage device, at least one commodity description data based on the user request data, wherein the at least one response data comprises the at least one commodity description data corresponding to at least one of a cost and an availability of the at least one commodity.

9. The method of claim 8, wherein the method further comprises:
receiving, using the communication device, at least one selection data from the at least one user device, wherein the at least one selection data comprises at least one of a selected commodity data and a payment preference data corresponding to the at least one commodity, wherein the payment preference data corresponds to a preferred payment method, wherein the preferred payment method comprises at least one of an online payment and a cash on delivery, wherein the payment preference data further comprises at least one of a Unified Payment Interface address data, a credit card data, and a debit card data; and
processing, using the processing device, at least one transaction based on the payment preference data, wherein the generating of the at least one response data is further based on the processing of the at least one transaction.

10. The method of claim 8, the method further comprising:
transmitting, using the communication device, the at least one user request data to at least one online service platform; wherein the at least one online service corresponds to at least one e-commerce platform; and
receiving, using the communication device, the at least one commodity description data from the at least one online service platform, wherein the generating of the at least one response data is further based on the at least one commodity description data, wherein the at least one commodity description data corresponds to the at least one of a cost and an availability of at least one commodity.

11. A system for provisioning digital content in accordance with a regulation, the system comprising:
a communication device configured for:
receiving at least one user request data from at least one user device associated with at least one user; and
transmitting at least one response data to the at least one user device;
a processing device configured for:
analyzing the at least one user request data based on at one regulation data, wherein the at least one regulation data corresponding to a regulation of at least one community, wherein the at least one user is associated with the at least one community, wherein the processing device implements an AI algorithm; and
generating the at least one response data based on the analyzing, wherein the at least one response data is compliant with the at least one regulation data.

12. The system of claim 11, wherein the at least one user request comprises a user query data, wherein the at least one response data comprises a bot response data, wherein the AI algorithm corresponds to an intelligent chatbot, wherein the AI algorithm configured to conduct a conversation with the at least one user, wherein the conversation is compliant with the at least one regulation data.

13. The system of claim 12, wherein the analyzing comprises detecting an event data based on at least one of the at least one user request data and the at least one regulation data, wherein the event data is associated with an event, wherein the at least one regulation data comprises a calendar data, wherein the generating the at least one response data is further based on the event data, wherein the at least one response data further comprises a recommendation data corresponding to a recommendation associated with the event.

14. The system of claim 11, wherein the at least one user request data comprises performance data representing performance of an activity, wherein the analyzing comprises detecting a rating data representing a performance rating of the activity, wherein the at least one response data comprises a recommendation data corresponding to a recommendation based on the rating data.

15. The system of claim 11, wherein the at least one user device comprises an Internet of Things device, wherein the at least one response data comprises a command data, wherein the command data corresponds to a command to control an operational state of the at least one IoT device.

16. The system of claim 11, wherein the communication device is further configured for receiving the at least one regulation data from at least one of a regulation platform and the at least one user device, wherein the at least one regulation data corresponds to at least one of a study material, a prayer time, a calendar, a minyan location and news of the at least one community, wherein the at least one user comprises an administrator, wherein the administrator is associated with to at least one of a religious community and an organization

17. The system of claim 11, wherein the communication device is further configured for receiving at least one preference data from the at least one user device, wherein the at least one preference data comprises at least one of a user role data and a login credential data and a personal data, wherein the user role data comprises data corresponding to role of the at least one user, wherein the role comprises at least one of an administrator role, a service provider role, and service receiver role, wherein the system further comprises a storage device configured for storing the at least one preference data of the at least one user, wherein the generating of the at least one response data is further based on the at least one preference data.

18. The system of claim 11, wherein the user request data corresponds to at least one commodity, wherein a storage device configured for retrieving at least one commodity description data based on the user request data, wherein the at least one response data comprises the at least one commodity description data corresponding to at least one of a cost and an availability of the at least one commodity.

19. The system of claim 18, wherein the communication device is further configured for:
receiving at least one selection data from the at least one user device, wherein the at least one selection data comprises at least one of a selected commodity data and a payment preference data corresponding to the at least one commodity, wherein the payment preference data corresponds to a preferred payment method, wherein the preferred payment method comprises at least one of an online payment and a cash on delivery, wherein the payment preference data further comprises at least one of a Unified Payment Interface address data, a credit card data, and a debit card data, wherein the processing device is further configured for processing at least one transaction based on the payment preference data, wherein the generating of the at least one response data is further based on the processing of the at least one transaction.

20. The system of claim 18, wherein the communication device is further configured for:
transmitting the at least one user request data to at least one online service platform, wherein the at least one online service corresponds to at least one e-commerce platform; and
receiving the at least one commodity description data from the at least one online service platform, wherein the generating of the at least one response data is further based on the at least one commodity description data, wherein the at least one commodity description data corresponds to the at least one of a cost and an availability of at least one commodity.
